(19) United States
(12) Patent Application Publication
(10) Pub. No.: US 2022/0225106 A1
(43) Pub. Date: Jul. 14, 2022

(54) METHOD FOR REGISTRATION OF A USER IN A DEFINED AREA AND SYSTEM FOR CARRYING OUT THE METHOD

(71) Applicant: Kirill KULAKOVSKIJ, Karlovy Vary (CZ)

(72) Inventor: Kirill KULAKOVSKIJ, Karlovy Vary (CZ)

(21) Appl. No.: 17/610,174

(22) PCT Filed: May 15, 2019
(86) PCT No.: PCT/IB2019/000514

§ 371 Date: Nov. 10, 2021

(51) Int. Cl. H04W 12/64; G07B 15/06; H04W 12/30

(52) U.S. Cl. CPC H04W 12/64; H04W 12/35; G07B 15/06

(57) ABSTRACT

The invention relates to a method for registering the presence of a user in a given zone, as well as a system for implementing said method. The user is equipped with a mobile user device with a pre-installed user mobile application. The user gains access to the given zone by at least one entry zone. The method includes the following steps performed in sequence: during or after installation of the application on the mobile device, a first data packet containing a first key is transmitted from a central server or local computer to the application; when the user mobile device with the application installed thereon enters the entry zone of the given zone, a second data packet containing a second key known to the local computer is transmitted wirelessly to the application, wherein transmission of the second data packet is done by means of at least one transceiver with a directional antenna, creating the entry zone; a third data packet containing data about the first and second keys, an identifier of the user mobile device, and/or SIM card identification data is transmitted from said user mobile device with installed application to the local computer via the at least one transceiver; on the basis of the first and second keys, a ticket containing at least one fillable first digital container is generated in the application, the ticket is saved in the user mobile device, and at least one fillable second digital container containing the third data packet is generated on the local computer, the second digital container being saved on the local computer.

### FIELD OF INVENTION

The present invention relates to a method for registering a user in a given zone, as well as a system designed for implementing said method. The registration of the presence of a user in a given zone may be used, in particular:

when attending cultural and entertainment events,

in transit payment systems with the use of wireless mobile devices, for example, to organize the passage and payment for the transit by subway riders passing through a turnstile or without a turnstile,

by passengers of public transportation with or without assignment of passenger seats,

by drivers paying tolls to enter the city center, being given access and making payment for car-sharing transportation,

when using toll roads with on-site payment-receiving points in the form of systems with a pass-through device or in systems of payment for road use in the form of systems not blocking the road for transit by automobiles such as archways to register truck travel on the road, as well as

in event of access to zones with prepaid tickets, for example, parking with barrier access or with turnstiles.

The aforementioned instances are merely examples and do not limit the scope of use of the present invention.

### PRIOR ART

A system designed to control user access to a given zone, containing gates that block the entrance to a parking area or to protected premises is known from document US 2016/055697 A1. In another usage variant, it is a system for mass transit, for example, for the entrance to a subway, where some form of paid transit control is usually employed, and it may be used in places such as concert halls, stadiums, and so on. Said system may include end user mobile devices, in which an access control application may be downloaded for exchanging information with beacons, such as Bluetooth, IBEACONS, Wi-Fi access points, and so on, and with zone computers for control of access to a given zone. Each zone computer can be linked to another one situated in the access control zone. The system may comprise any given number of beacons and zone computers, depending on how many signals from users need to be processed at the same time when controlling access to the given zone.

There is a known method for implementing an automatic payment for transit in a transportation system (US 2017/046681), which involves installing on a means of transportation a local computer with a wireless interface operating in a zone of wireless detection of a mobile user device with an application installed on the device. The zone of wireless detection of the user device extends at least within the boundaries of the means of transportation. This method also includes a step in which it is determined that a first user device is located alongside the means of transportation, and then a wireless interface is used to transmit an identifier of the means of transportation to a mobile application installed on the first user device. The identifier so received is displayed in the user interface of the mobile application. In a following step, a message is received from the mobile application to the effect that the identifier of the means of transportation has been selected for registration of the first user device in said means of transportation. The registration message is received at a first location and contains a first unique identifier of the first user device and data on the first location. In a following step, it is established that the first user device is situated on the means of transportation, this being done by periodic polling of the first user device during the transit from the first location to a second location. In the next step, when the means of transportation is at the second location or in its proximity, it is determined that the first user device has left the means of transportation, since it is no longer detected within the boundaries of the wireless detection zone. In the final step of the method, calculation of payment for the travel of the user of the first user device is initiated on the basis of the first location and the second location.

Variants are also contemplated when the mobile user device has been detected already after the start of movement of the means of transportation, that is, between the first and second location. In this case, an additional message as to tardy registration is sent to the user device and/or to the transit control device.

The methods for registration of a user in a given zone that are known in the art do not guarantee a reliable registration, and moreover they are adapted only to a particular type of transportation, such as subway or bus. Hence, there is a need for an effective and reliable method of user registration in a given zone, as well as a system to implement such method, which have no disadvantages of the prior art.

### DISCLOSURE OF THE INVENTION

The present invention solves the technical problem of enhancing the effectiveness and reliability of registration of a user in a given zone. In particular embodiments, the present invention solves the problem of enhancing the effectiveness and reliability of operating a ticketing system for registration and subsequent payment for passenger travel on public transportation and payment for transit by drivers of automobiles on toll roads by eliminating unauthorized debiting of funds for travel, increasing the radius of operation of the mobile application, speeding up the ticket issuing process, speeding up the entry procedure, and thus, it constitutes a new kind of control for proper payment and convenience of the users.

The present invention proposes that the user is equipped with a mobile user device on which there is installed a mobile user application (hereinafter, the application). By a mobile user device is meant in particular a smartphone, a tablet, or any given portable device with a processor, an internal memory, and the ability to provide communication by a wireless radio channel and with an operating system of Apple iOS, Android, Windows, Blackberry types or the like, pre-installed on the mobile device.

The systems for registration of a user in a given zone that are known in the art propose the use of tokens, whose radius of action and functionality are greatly restricted. The use of a mobile device in the present invention results in increasing the radius of action of the mobile user device as compared to tokens.

The application installed on the mobile device is configured with possibility of being adapted for use with different payment and/or registration systems. Thus, for example, in the case of automobile travel on toll roads of different countries, it is enough for the user to have only one mobile device with pre-installed application. The creating of the ticket and the filling out of the ticket will be done automatically, regardless of the special features for registration and payment in each particular country.

In the present invention, the given zone means any limited zone to which users have access through at least one entry zone. The presence of the user in the given zone presupposes detecting the presence of the user in the given zone and/or a payment for services and/or cultural and entertainment events provided in the given zone. Thus, for example, the given zone may be defined as: the premises of offices, museums, exhibits, theaters, and other cultural and entertainment centers, a section of the route of a means of transportation between stops, a section of the route of a means of transportation of a particular toll zone, the compartment of a means of transportation, or at least one section of a toll road.

In one embodiment of the invention, when the given zone is the passenger compartment of a means of transportation in a public transit system, the given zone may be provided to encompass either the entire passenger compartment or a previously designated passenger area as an additional given zone, or a combination of both zones.

The method according to the present invention comprises the following steps:
during or after installation of the application on the mobile device, a first data packet containing a first key is transmitted from a central server or local computer to the application,
when the user mobile device with the application installed thereon enters the entry zone of the given zone, a second data packet containing a second key known to the local computer is transmitted wirelessly to the application, wherein the second data packet is transmitted by means of at least one transceiver with a directional antenna, creating the entry zone,
a third data packet containing data about the first and second keys, an identifier of the user mobile device, and/or SIM card identification data is transmitted from said user mobile device with installed application to the local computer via the at least one transceiver,
on the basis of the known first and second keys, a ticket containing at least one fillable first digital container is generated in the application, the ticket is saved in the user mobile device, and at least one fillable second digital container containing the third data packet is generated on the local computer, the second digital container being saved on the local computer.

It is important that the information relating to the ticket is saved independently in two digital containers in devices independent of each other. This helps prevent possible manipulations involving the user being in the given zone and with subsequent payment.

The local computer and/or central server are an example of a general-purpose computer system, which comprises a central processor, a system memory, and a system bus containing various system components, in particular information storage media. The local computer and the central server are designed to work in a network environment. The network connection is implemented by a wireline and/or wireless interface. The local computer is adapted to periodically connect to the central server, which is situated outside the bounds of the given zone.

In the event that the mobile device of the user is situated successively in several given zones, a transit key from a central server or local computer is transmitted to the mobile device. When the mobile device enters the entry zone of the first and each subsequent given zone, the following additional steps are carried out:
i. the mobile device fills up the first digital container with the transit key and sends the third data packet filled with the transit key to the local computer, or
ii. if the local computer does not receive a reply from the mobile device of the user or if the signal from the local computer is not received by the mobile device of the user after a given interval of time or on command from the local computer, the mobile device closes the existing first digital container and creates a new first digital container, in which the first key is replaced by the transit key or in which the transit key is used jointly with the first key, fills up the ticket with the new first digital container, and sends the third data packet with the new first digital container to the local computer,
   wherein the local computer creates a new second digital container by using the third data packet it received.

In one embodiment of the invention, in the method according to the present invention, it is further provided that, after receiving the third data packet by the local computer, a verification of the received data is carried out by the local computer. In the event that the reliability of the received data from the third data packet is confirmed, a wireless communication channel is established between the local computer and the mobile user device with the installed application. The channel so established is used to send from the local computer to the mobile user device a fourth data packet containing a third key. After receiving the fourth data packet created in the application on the mobile user device, the first digital container is filled up with data on the third key, the filled first digital container is saved in the ticket in the mobile user device, and a fifth data packet containing at least data on the identifier of the first digital container is sent from the mobile device to the local computer, in which data on the identifier of the first digital container are also saved in the second digital container.

The verification of the data received from the mobile device and the sending of the third key from the local computer further increases the level of protection of the method according to the present invention against mistakes for the registration of a user in a given zone and subsequent manipulations with the payment.

In one embodiment of the invention, it is provided that at least one entry zone of the given zone is equipped with a pass-through device. After the fifth data packet is received by the local computer, a signal is produced on the local computer to open the pass-through device and the signal so produced is sent to open the pass-through device.

In one embodiment of the invention, it is provided that during the presence of the user in the given zone an exchange of additional data occurs between the local computer and the mobile user device and/or between the mobile user device and other mobile devices of other users situated in the given zone that are in the receiving zone of the mobile user device, and the additional data are saved in the first and second digital containers in the mobile user device and in the local computer, respectively. In one embodiment it is also provided that the exchange of additional data occurs periodically. It is also provided that the first and/or second digital containers are adapted to save data on all events being transmitted by the local computer not only for the particular user, but also for all users having mobile devices with installed application who are located on the means of transportation. In a particular embodiment of the invention, data in the first and second digital containers are saved in the form of a blockchain, which is an uninterrupted sequential chain of data blocks containing information constructed according to certain rules.

The exchange and the saving of additional information are especially important in the case of travel of the user in passenger transportation or on a section of a toll road. That is, it becomes possible to track the stay of the user in the given zone in those cases when payment for the stay is directly related to the length of the stay and/or the length of the route. The fact that data are saved on all users of the means of transportation increases the reliability of the data being saved in the digital containers, and thus, the accuracy of the calculation for payment for the trip. The independent creation and saving of a ticket containing at least one digital container, as well as a second digital container, in two locations, that is, a dual saving of the digital containers both on the mobile device and on the local computer, helps prevent unauthorized alteration of the data of the ticket/container due to unlawful actions by criminals or malfunctions in the travel payment system. The dual verification of the ticket is possible because, in the first place, the ticket is saved by the application in the mobile device after it has been created, and in the second place the ticket data in the form of the second digital container is created independently in the local computer on the basis of signals received from the mobile device with the application. The sending of data about the ticket in the form of at least one digital container to the central server separately from the local computer and the mobile device with the application allows the received tickets to be compared to each other afterwards on the central server.

In a particular embodiment of the invention, it is provided that the first and second digital containers are closed in the event of occurrence of at least one of the following conditions:
if the local computer does not receive a reply from the mobile user device,
if the mobile user device does not receive a signal from the local computer after a given interval of time,
if the user with the mobile user device crosses through the entry zone for a second time,
when the mobile user device is located in a means of transportation having a route through the given zone, upon command from the local computer before opening the doors at the next stop of the means of transportation, in which case the first and second digital containers are again opened on command from the local computer after closing the doors or the corresponding first and second digital containers are left closed and a new first and second digital container are opened,
on command from the local computer.

Since, in the method according to the present invention, the step of closing the first and second digital containers is strictly defined and dictated by a series of conditions, there is no possibility of charging too much for the stay of the user in the given zone. It is also important that the closing and, when necessary, the reopening of the first and second digital containers occurs synchronously, that is, after performing at least some of the aforementioned conditions. In this way, a set of data containing common information for the mobile device and the local computer is saved in two independent parts of the system, the mobile device and the local computer.

In a particular embodiment of the invention, when the given zone is a route of a means of transportation or a section of a toll road, the exchange of additional data occurs when the means of transportation passes through a stop along the route or at reference points of the section of toll road, the first and/or the second digital container additionally containing a record of events connected with the user entering the given zone and/or the user staying in the given zone.

In the event that the user is a passenger of a means of transportation with seat assignment, the given zone of a passenger compartment of a means of transportation following a route along a given zone, the passenger compartment includes an additional given zone, which is created with the aid of an additional transceiver with a directional antenna, the additional given zone being limited to one passenger seat, and information on the user with the mobile device being located in the additional given zone is saved in the first and second digital containers. Thus, the solution proposed in the method according to the present invention may be applied to cases of passenger travel when there is a need to register the fact of travel in a specific passenger seat in addition to registration of the fact of the passenger being in the means of transportation en route in the given zone.

In one embodiment of the invention, the entry zone may include a first entry zone and a second entry zone. This embodiment may be realized, for example, in the case of a toll road, when the approach zone to a payment point on the toll road is the first entry zone, and a selected metering section through which the user enters the toll road is the second entry zone. The second data packet with the second key is sent to the mobile device in the form of two packets, each of which contains a portion of the second key, the first portion of the second data packet containing the first portion of the second key being sent to the mobile device when the mobile device enters the first entry zone, and then the second portion of the second data packet containing the second portion of the second key is sent when the mobile device enters the second entry zone, the first and second entry zones being arranged such that the mobile device approaching the entry zone first enters the first entry zone, and then the second entry zone. In this case, the user who intends to travel on a selected section of the toll road in an automobile can proceed unhindered to the necessary section, almost without decreasing the speed of the automobile, since all the steps of the user registration take place automatically, without the involvement of the human operator. In turn, the proposed solution can increase the through capacity of entry points to a toll road, constituting entry zones.

In a particular embodiment of the invention with two transceivers having directional antennas, the entry zone is created by the intersection of the beams of the directional antennas of the transceivers to create a three-dimensional entry zone, each of the beams being specified by corresponding lobes of the directionality diagram of the corresponding directional antenna. Thus, a three-dimensional entry zone with strictly defined boundaries can be created, which is important, for example, in the case when users are passing through turnstiles in the subway or when automobiles are moving through certain metering sections for entrance to a toll road.

In a particular embodiment of the invention, the contents of the first digital container are additionally sent from the mobile device to the central server after completing the creation of the first digital container. Moreover, the contents of the second digital container may be additionally sent to the central server from the local computer of the given zone after completing the creation of the second digital container, the contents of the first and second digital containers being sent independently of each other from the mobile device and from the local computer, respectively, to the central server. Thus, the first digital container kept in the user's ticket may be compared independently on the central server with the content of the second digital container from the local computer, that is, it is possible to perform a further independent check for the complete and correct ticket data.

The above described method according to the present invention is implemented with the aid of a system for registration of the presence of a user in a given zone, the given zone including at least one entry zone. The system according to the present invention comprises: a central server, a local computer, at least one transceiver with a directional antenna installed in the entry zone and creating the entry zone, wherein at least one transceiver is linked to the local computer by a communication line, and a mobile user device with mobile user application pre-installed on it.

The central server is linked by the communication channel to the mobile device for the sending of a first data packet, containing a first key, to the mobile device, and it is adapted to establish a link with the local computer. The sending of the first data packet occurs during or after the installation of the application on the mobile device. The transceiver with directional antenna is adapted to send the second data packet, containing the second key known to the local computer, to said application and to receive the third data packet by wireless communication channel from the application of the mobile device. The third data packet contains data about the first and second keys, the identifier of the mobile user device, and/or SIM card identification data. The mobile user application is adapted to create a ticket containing at least one fillable first digital container after obtaining the first and second key and to save the ticket in the mobile user device. The local computer is adapted to create at least one fillable second digital container containing the third data packet, and to save the second digital container on the local computer.

In a particular embodiment of the system, the transceiver comprises a processor, a memory unit, a power supply unit, and a directional antenna.

Other aspects of the method and system according to the present invention will be presented below in a detailed description with references to the appended drawings.

### BRIEF DESCRIPTION OF THE DRAWINGS

Embodiments of the invention are described in detail below, with references to the following drawings:

FIG. 1 shows the basic components of the system for registration of a user in a given zone according to the present invention;

FIG. 2 shows the creation of an entry zone with the aid of two transceivers with directional antennas;

FIG. 3 shows the basic steps of the method for registration of a user in a given zone according to the present invention;

FIG. 4 shows additional steps of the method according to the present invention, involving the presenting of a third key to the user;

FIG. 5 shows the arrangement of the components of the system according to the present invention in the case of an open avenue (a) to a section of toll road and an avenue with a barrier (b), the second key being sent in parts by corresponding transceivers with directional antennas.

### DETAILED DESCRIPTION OF THE INVENTION

The particular embodiments explained below are given for the purpose of a more complete understanding by the person skilled in the art of the idea of the present invention and in no way limit all possible embodiments of the present invention.

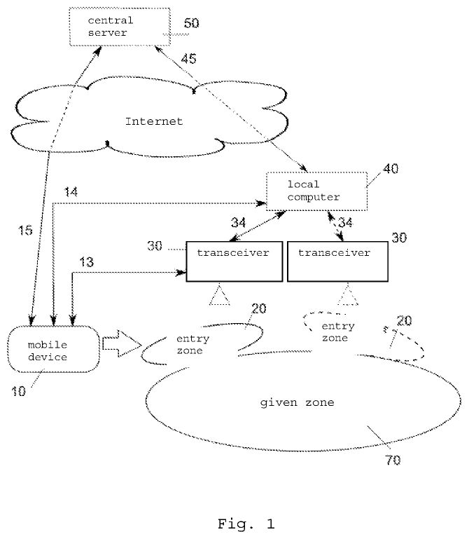

As shown in FIG. 1, the system according to the present invention comprises the following main components: a central server 50, a local computer 40, at least one transceiver with directional antenna 30, and a mobile user device 10 with application installed on it.

The central server 50 is adapted to be linked to all the mobile user devices 10, as well as all the local computers 40 belonging to the system in such a case when the mobile devices 10 and the local computers 40 are set up to communicate with the central server 50. The direct connection of the mobile device 10 to the central server 50 occurs by a communication line 15 when the mobile device 10 is connected to the Internet.

The local computer 40 is coordinated with the given zone 70 and designed to process all the signals, to create the second digital container and later store in the second digital container the data received from the mobile device to verify the data received during periodic or continual communication with the mobile device 10, to receive signals with communications from the mobile device 10, and to send signals with communications to the mobile devices 10 located at the present time in the given zone 70, and under periodic or constant communication with the central server 50. Furthermore, the local computer 40 is designed to send to the application a third data packet containing the third key and later save the third data packet in the second digital container, to obtain a signal with information about the first digital container located in the ticket and created by the application in the mobile user device, to keep a record of all events, such as the tickets sold, the checks performed by the controller, the system failures, and so on, and to send communications to the central server. The local computer 40 is likewise adapted to verify the working capacity of the entire system by conducting internal diagnostics of the transceivers and by conducting a functional test on the receival of information from a monitoring transceiver, which is one of several transceivers 30 involved in checking the working capacity of the antennas of several transceivers. The local computer is likewise adapted to display service information to the operator of the given zone on the screen of his mobile or stationary device. The above indicated features of the local computer 40 may be combined with each other in accordance with the embodiments of the invention as presented in the specification or the patent claims.

The local computers are connected to the central server 50 by a communication line 45 or by wireline or wireless communication, in particular, by means of the Internet. As shown in FIG. 1, each local computer 40 is associated with a corresponding, previously determined given zone 70. These given zones 70 may be office rooms, zones of attended cultural and entertainment events, such as museums, concerts, and so on. The given zones 70 also pertain to sections of the route of means of transportation between stops and sections of the route of means of transportation of a particular fee zone, and also sections of a toll road, parking zones, and so forth. A given zone may also be a compartment of a means of transportation, and it may be provided that the given zone may include both the entire passenger compartment and a previously assigned passenger seat as an additional given zone, or a combination of both zones.

In one particular embodiment of the given zone 70 within the boundaries of a means of passenger transportation or within the boundaries of a route of a means of transportation, the local computer 40 is installed on the means of transportation. The user gains access to the given zone 70 through at least one entry zone 20. FIG. 1 shows a case with two entry zones 20.

The user, equipped with a mobile device 10, installs the application on the mobile device 10 by downloading it, for example, from the central server 50 or the local computer 40. In the event of loading the application from the local computer 40, the link is established by the line of communication 14 between the mobile device 10 and the local computer 40. The application of the mobile device 10 is adapted to be activated upon entering the entry zone 20 specified for receiving the second key; outside the entry zone, the application cannot be activated to receive the second key. In a particular embodiment, the application of the mobile device 10 has a permanent storage for messages for the user and a temporary storage for messages that have been created, where the messages are kept awaiting their sending to the central server 50, and also a temporary storage of reserved means in the form of a unified counting system, i.e., money, rides, made-up units, and so forth, to be used by the system as an accounting unit for fares and travel for the given territory.

One may use as the mobile device 10, for example, a smartphone, tablet, or other portable device with a processor, internal memory, and capability of providing communication by wireless radio channel. During the installation of the application or after the installation on the mobile device 10, a first data packet will be sent, containing the first key. The first key is essentially the key of the application itself on the given mobile user device. In a particular embodiment, the first key may play the role of a key activating the application. Also, in a particular embodiment of the invention, a periodic updating of the first key may be provided, being received by the mobile application 10 from the central server 50.

After the installation of the application on the mobile device 10 and after receiving the first data packet, the user is able to enter the given zone 70 through at least one entry zone 20. For example, in the case of a means of passenger transportation, the entry zone 20 is located at the entrance(s) of the means of transportation or at the entrances to the platform in the case of a subway.

Each entry zone 20 is created by at least one transceiver 30 with a directional antenna. Although FIG. 1 shows a variant with two entry zones 20, there may be one or more than two entry zones 20. Each transceiver 30 is linked by a wireline or wireless communication to the corresponding local computer 40 by a communication line 34. The zone of radiation and reception of the directional antenna is characterized by beams with a directionality diagram having the shape of lobes. A lobe of the directionality diagram of the directional antenna forms the zone of reception of a signal from a transceiver 30, thereby forming a virtual swath, or entry zone, in which the mobile device 10 receives signals from the transceiver 30 containing permanent data, in particular, the identifier of the transceiver, and variable data. The variable data include the second key, the identifier of the stop of the means of transportation, and additional variable data. The additional variable data are formed individually for each ticket or group of tickets by an algorithm which takes into account different factors. The option is also provided of a periodic updating of the algorithm by wireless channel during the operating process, which is necessary to ensure a secure operation of the system. The presence of variable data formed by the transceiver 30 and monitored by the local computer 40 enables a primary protection against failures in the given zone 70, for example unauthorized debiting of funds, and it is a system security factor.

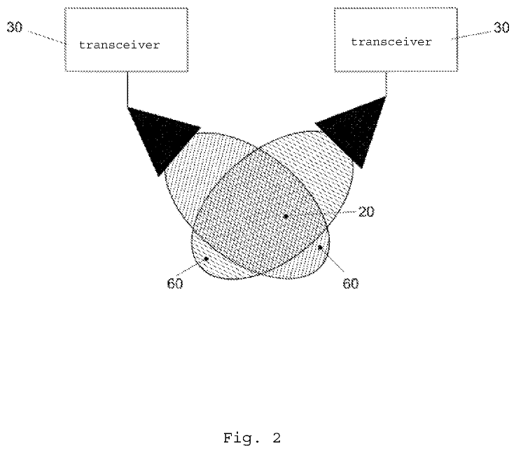

As shown in FIG. 2, in the case when two or more transceivers 30 with directional antennas are used, the entry zone 20 is three-dimensional due to the intersection of the beams of the directional antennas. Each of the transceivers 30 with directional antennas forming the entry zone is adapted to send a set of data, which is unified for all of the antennas, including either information about the identifier of the particular entry zone and/or the identifier of at least one transceiver forming the entry zone 20. In a preferred embodiment, the transceiver 30 comprises a processor, a memory unit, a power supply unit, and a directional transceiver antenna.

In a particular embodiment of the invention, the transceiver 30 with a directional antenna or several transceivers 30 with directional antennas can be installed above or at both sides of the entry zone, for example, above the doors inside the means of transportation or in the side walls of a turnstile or, for example, above the barrier of a toll payment station on a toll road. If need be, several transceivers 30 forming an entry zone 20 may be combined into a block of transceivers 30. In the case of a means of passenger transportation, such a block of transceivers 30 can be implemented as a door panel above the entrance of the means of passenger transportation.

The three-dimensional entry zone in the case of a means of transportation is bounded on the outside by a line coinciding with the entrance line to the compartment of the means of transportation, or by the boundary line of the toll payment station on a toll road, and it extends into the inside of the compartment of the means of transportation or the toll payment station on the toll road, respectively. This is especially important in the case when the heights at which the mobile user device is placed may be different.

With proper arrangement and orientation of the directional antennas, the dimensions and position of the three-dimensional entry zone are strictly defined and situated within predetermined boundaries, for example, within the side walls of a turnstile in the subway or the gate of the entrance point to a section of toll road. Because of the mutual arrangement of the directional antennas, a uniform zone is created for the reception of the signals, thereby significantly increasing the accuracy of determining the reception distance, and the signal levels from different mobile devices of the users are unified. The creation of a three-dimensional entry zone can also provide a highly reliable determination of the user's location, since the requisite reception characteristics are possible only in the zone of intersection of the lobes of the directionality diagrams of the directional antennas When the mobile device enters the zone of intersection of the lobes of the directionality diagrams of the directional antennas, it is provided that a communication between the mobile device 10 and the local computer 40 will be established if all the transceivers 30 with antennas directed at the same entry zone 20 confirm the reception of the signal on the line of communication 13.

Upon entering the entry zone 30, the mobile user device 10 with working application will receive a second data packet containing a second key on the line of communication 13 from the transceiver 30 creating said entry zone 20. In addition, the transceiver is adapted to send its own transceiver identifier to the mobile device 10. The mobile device 10 is adapted to connect to the transceiver with directional antenna by wireless communication 13, which may be a wireless communication 13 having a short range of action, such as one in the Bluetooth or Bluetooth Low Energy (BLE) standard.

The second key which is sent to the application on the mobile device 10 is known to the local computer 40, which is coordinated with said entry zone 20. An embodiment of the invention is also proposed whereby the mobile application receives the second key in the form of unified data from several transceivers 30 or a signal from each transceiver 30 separately, which taken together will transmit the second key in its entirety or a certain portion thereof, besides the unique identifiers of the transceivers 30. In a particular embodiment of the invention, the second key consists of two parts, the first of which is sent, for example, upon entering the passenger compartment of the means of transportation, and the second—upon sitting down on a particular seat in the passenger compartment.

The application on the mobile device 10 in response to receiving the second key creates a third data packet, which contains the first and second keys, as well as the identifier of the mobile device 10 and/or identification data of the SIM card installed in the mobile device 10. That is, the third data packet contains full information on both the installed application in the form of the first key and the entering of the corresponding entry zone in the form of the second key, as well as information identifying the particular mobile device 10. The third data packet will be sent to the corresponding local computer 40 by means of at least one transceiver 30.

The application on the mobile device 10 then creates a ticket containing at least one fillable first digital container. The digital container is a virtual file for non-erasable storage of records as to reference events in the course of the presence of the mobile device 10 in the given zone. The first digital container so created includes at least data about the first key and the identifiers of the mobile device 10 and the application, as well as data about the second key and identifiers of at least one transceiver 30. Since the first digital container is a fillable digital container, it can be filled with additional data in the course of the user's stay in the given zone. The ticket so created, containing the first digital container, is saved on the mobile device 10.

At the same time as the ticket is created on the mobile device 10, the local computer having received the third data packet saves these data in a second digital container. In a preferred embodiment, the data in the first and second digital containers are saved in blockchain form, which allows the first and second digital containers to be filled afterwards with additional data or to open subsequent first and second digital containers and thereby avoid possible falsification or loss of data. In this way, a data set containing information common to the mobile device 10 and the local computer 40 is saved in two independent parts of the system, the mobile device 10 and the local computer 40. This leads to the increased overall reliability of the system according to the invention.

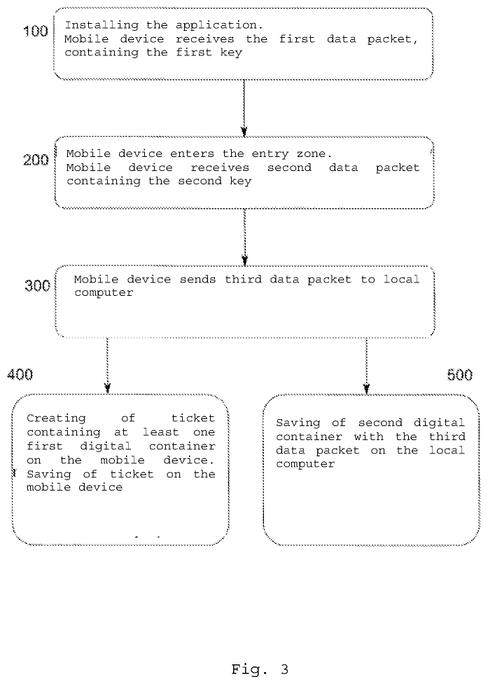

The above steps demonstrate the operation of the system according to the present invention in the form of an information gathering system. Said steps are the steps of the method according to the present invention as presented in the block diagram of FIG. 3. Indeed, after installing the application on the mobile device 10 in step 100, the mobile device 10 receives the first data packet containing the first key. When the mobile device 10 enters the entry zone 20 in step 200, the mobile device 10 receives a second data packet, containing the second key. After that, the mobile device 10 creates the third data packet and sends it to the local computer 40. Then, in step 400, the mobile device 10 creates and saves the ticket containing at least one first digital container. Furthermore, simultaneously with step 400, the third data packet in the form of the second digital container is saved on the local computer 40 in step 500.

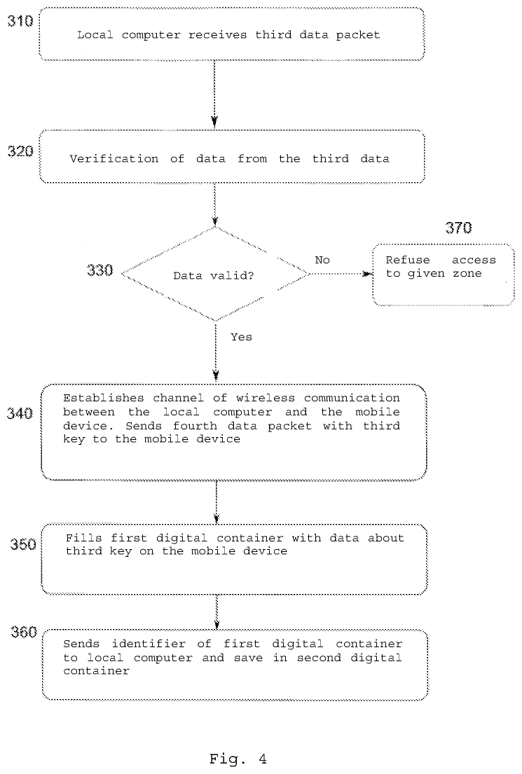

The block diagram presented in FIG. 4 shows additional steps of the method according to one variant of the present invention, providing additional reliability for the registration of the presence of a user in a given zone and also, additional functional capabilities of the system, such as the opening and closing of a pass-through device. In a particular embodiment, in step 310, which is performed after step 300 in FIG. 3, the local computer 40 receives the third data packet from the mobile device 10. After that, in step 320, the local computer 40 performs a verification of all data from the third data packet, including a verification of the source of the second key for the application. In the event of confirming the reliability of all the data from the third packet in step 330, the local computer 40 in step 340 establishes a first channel of wireless communication 14 between the local computer 40 and the mobile device 10. On the first channel 14 so established, the local computer 40 sends a fourth data packet containing a third key, to the mobile device 10. The third key is strictly defined for each entry zone. If the data of the third key prove to be untruthful, then in step 370, the system refuses the user access to the given zone.

The mobile device 10, having received the fourth data packet, in step 350 fills the first digital container with data about the third key and saves the filled first digital container in the ticket in the mobile device 10. Step 350 of the method is carried out after the ticket has been created in step 400, as shown in FIG. 3. In addition, the mobile device 10 in step 360 sends to the local computer 40 a fifth data packet containing data on the identifier of the updated first digital container. The data received about the identifier of the first digital container are saved on the local computer 40 in the form of a supplement to the second digital container, which is created in step 500 (FIG. 3). Thus, information regarding the presence of the user in the given zone, which contains information common to the mobile device 10 and the local computer 40, is saved in two independent devices, the mobile device 10 and the local computer 40.

The system according to the present invention, which implements all of the steps of the method in FIGS. 3 and 4, operates as a system that gathers and verifies information.

In particular embodiments of the invention, it is further proposed to send the content of the first digital container from the mobile device 10 to the central server 50 by the line of communication 15 shown in FIG. 1. Moreover, it is proposed to send the content of the second digital container to the central server 50 from the local computer 40 by the line of communication 45. In this case, the first and second digital containers will be sent independently of each other to the central server 50.

In particular embodiments of the invention, it is proposed to create the ticket by the application on the mobile device in “offline” mode, when the mobile device 10 is not connected to the Internet. The link between the mobile device 10 and the local computer 40 in this case is implemented by a first channel 14 of short-range wireless communication. The sending of the first digital container to the central server 50 by the mobile device 10 is done either directly by the line of communication 15, when the mobile device is connected to the Internet in “online” mode, or through local computers of other means of transportation present in the zone of operation of the wireless communication 14, or through mobile devices 10 of other users with the installed application, which send the data of that first digital container in a chain to the central server 50. If the application of another user that is installed in the mobile device 10 is also not connected to the Internet, that is, it is in “offline” mode, then that application will send the data received during the next communication session with any local computer 40 of any means of transportation that is connected to the system according to the present invention.

The local computers 40, as well as the processor units of the transceivers 30, receive a regular updating, for example, with data storage media such as flash cards, and also through constant or periodic connection by the line of communication 45 to the central server by way of a wireline or wireless connection or in “online” mode.

In particular embodiments of the invention, it is proposed that the local computer 40 and the processors in the transceivers 30, which are coordinated with the given zone, can also work in “offline” mode during actions directly related to the creation of the ticket, and in “online” mode, “session online” mode, or entirely “offline” in the case of updating, receiving the requisite updates during the wireline or wireless connection by the line of communication 45 to the central server 50 without going onto the Internet, for example, by exchanging information through service WiFi, for example at stops, at the depot, or by connecting an information storage medium in the computer socket. Updating of the keys of the application in “offline” mode can be done through a secure connection to the local computers on board the means of transportation.

Moreover, the local computer 40 is adapted to check the working capacity of the entire system by diagnostics of the transceivers 30 and performing a functional test to receive information from a monitoring transceiver (not shown in the drawings). One of the transceivers 30 associated with the local computer 40 is used as the monitoring transceiver. In a particular embodiment of the invention, in the case when at least two transceivers 30 are used, in addition to the directional antenna, one transceiver is equipped with an omnidirectional receiving antenna having a circular directionality diagram (not shown in the drawings). The omnidirectional receiving antenna, with which the transceiver is equipped, performs the monitoring of the functional capacity of other transceivers 30.

The local computer is adapted to present service information on the operator's screen of the given zone. The operator may be, for example, the driver of a means of passenger transportation, an operator of a toll pay station on a section of toll road, and so forth.

In particular embodiments of the invention, it is proposed to exchange additional data between the local computer 40 and the mobile device 10 during the course of the stay of the user in the given zone. In the course of this exchange, additional data are saved in the first and second digital containers, respectively, on the mobile device 10 and on the local computer 40. Thus, for example, the additional data might be the fact of passing through reference points, such as stops along the route of a means of passenger transportation, or reference points, such as pass-through points on a section of toll road. Said facts are recorded in the form of messages in the first and second digital containers, respectively. Afterwards, the calculation of the travel fare or the determination of the payment is done on the basis of the records of the reference points in the first and second digital containers.

The determination of the fact of passing through the reference points along the route of a means of transportation, such as passing through stops, is done in the form of a record in the first and second digital containers of notifications received in the form of a signal from the local computer 40, i.e., the local computer 40 at each stop sends a signal with a message as to the start of movement after a stop to the interior vehicle compartment through transceivers 30 with directional antennas functioning here as a repeater, or it reports on the passing through the entry zone at a toll pay station on a toll road. This message is received by the application and saved in the mobile device 10. The route for calculation of the travel fare or determination of the payment is based on the records of the reference points, such as the stops along the route of the means of transportation and/or the points of crossing a particular toll zone.

In a particular embodiment of the invention, it is proposed that the mobile application uses a controller, which checks the ticket containing at least one first digital container by checking the identifier of the first digital container, a code or a number in an alphanumerical expression, indicates the seats where the users are situated, for example where the passengers are seated, possibly not in their proper seats, indicates how many tickets have been sold in the given means of transportation, and so forth. In this case, the text data from the application screen are duplicated by a procedure of data exchange by radio between the controller application and the applications of the users, and also by at least one strictly defined data packet sent by radio by the user application to the controller application.

In one particular embodiment of the invention, a procedure is provided for closing the first and second digital containers, which takes place when at least one of the following conditions occurs.

One of the conditions for the closing of the first and second digital containers is when the local computer 40 does not receive a response from the mobile device 10.

Another condition for the closing of the first and second digital containers is when the mobile device 10 does not receive a signal from the local computer 40 after a given interval of time.

Yet another condition for the closing of the first and second digital containers is when the mobile device 10 crosses the entry zone once more. In this case, it is assumed that the user has left the given zone 70.

Yet another condition for the closing of the first and second digital containers is the case when the mobile device of a user is located in a means of transportation having a route through the given zone. Before opening the doors at the next stop of the means of transportation, the local computer 40 sends a command to close the first and second digital containers. After the closing of the doors of the means of transportation, the local computer sends a command to open the first and second digital containers once again, or it leaves the existing first and second digital containers closed and sends a command to open a new first and second digital container. In this case, the local computer 40 sends a query to the mobile device 10 as to whether it is on board the means of transportation. The mobile devices which have left the passenger compartment do not receive the commands to open the first digital container once again. Thus, their first digital containers remain closed.

In particular embodiments of the invention, it is provided that, after the first digital container is closed, the second and also the third key become inactive thereafter.

In a particular embodiment of the invention, in the event that several mobile devices 10 are present in the passenger compartment of a means of transportation, it is possible to record data about all the devices present on board the means of transportation in the first digital containers contained in the tickets which have been created on these mobile devices 10, and also in the corresponding second digital devices. In this case, data on the identifiers of the first digital containers of the other mobile devices 10 are flagged in the first digital containers created on the mobile devices 10. It is also possible to save data about the identifiers of the first digital containers of the other mobile devices in the second digital containers on the local computer 40.

In a particular embodiment of the invention, it is additionally proposed that the mobile user device 10 is present in several given zones 70 in succession. Examples of the mobile user device being present in several given zones 70 in succession might be the movement of a means of transportation along a route between consecutive stops, the movement of a means of transportation along a route passing through different toll zones, and the moving of the user's mobile device 10 to a different means of transportation.

In this case, a transit key is additionally sent from the central server 50 or the local computer 40 to the mobile device 10 of the user. When the mobile device 10 of the user enters the entry zone 20 of the first and each successive given zone 70, the first digital container is filled with the transit key, after which the mobile device 10 sends the third data packet, supplemented with the transit key, to the local computer 40. The closing of the existing first digital container and the creation of a new first digital container are done by the mobile device 10 in the following instances: when the local computer 40 does not receive a response from the mobile user device 10, or when the mobile user device 10 does not receive a signal from the local computer 40 after a given interval of time, or on command from the local computer 40. In this case, the first key is replaced by the transit key in the new first digital container so created, or the transit key is used together with the first key.

After this, the mobile device 10 fills the ticket with the new first digital container and sends the third data packet with the new first digital container to the local computer 40.

In turn, the local computer 40, having received the third data packet with the new first digital container, creates a new second digital container using the third data packet so received.

The above indicated steps are repeated when the mobile user device 10 enters entry zone 20 of each succeeding given zone 70.

The above described process of the mobile user device 10 being successively in several given zones 70 may also be extended to an embodiment of the invention in which the local computer 40 performs a verification of the data received from the mobile device with a third data packet. In this case, all of the above listed steps are repeated, but the mobile device 10 sends to the local computer not the third, but a fifth data packet containing data on the identifier of the first digital container from the mobile device 10. In turn, the local computer creates a new second digital container, making use of the fifth data packet so received.

An embodiment of the invention in which the transit key is received at the same time with the first key from the central server 50 can be realized, for example, in the event that the application is adapted for payment of a fare in a transportation network, in which the presence of a user is registered in accordance with the present invention. It is assumed that such a transportation network comprises various kinds of passenger transportation and includes different given zones, in which different rates are applied. In this case, it is provided that the user receives, besides the first key, also a transit key at the same time as the application is installed or after the application is installed on the mobile device 10. The transit key so received affords the additional right, during travel within that transportation network, to change means of passenger transportation unimpededly, and correspondingly, change one's presence in the different given zones. The presence of the transit key can automatically identify the mobile user device 10 during individual trips in different means of passenger transportation when moving throughout the transportation system.

If the user does not have a transit ticket valid for the entire transportation system, it may be provided that the application receives a transit key from the local computer 40 which is coordinated with that given zone 70 where the user is located at the start of their route. The need for having a transit key is provided, for example, in event of the need to switch from one means of transportation to another. If the user needs to use a ticket created for travel on a bus in order to travel on the subway, the application is adapted to obtain the corresponding transit key when the ticket is purchased from the local computer 40 of the given means of transportation. In the present example, that means of transportation is a bus. The system of passenger transportation may have rates applying to travel solely on a bus, as well as rates entitling one to travel on a bus and in the subway. The user selects the necessary rate when installing the application in the mobile device, and this is afterwards transmitted in a message to the local computer 40 of the means of transportation upon sending the third message with the first and second keys from the application of the mobile device 10. If a rate variant is chosen where the user can employ a ticket created for a bus in order to travel on the subway, or if this is allowed by the rates of the passenger transit system, then a third key and a transit key are sent at the same time in the bus upon generating a ticket by the local computer 40 of the bus. The presence of the transit key, which is received accordingly by the local computer 40 in the subway, as the next means of transportation, is added to the first digital container already created in the bus.

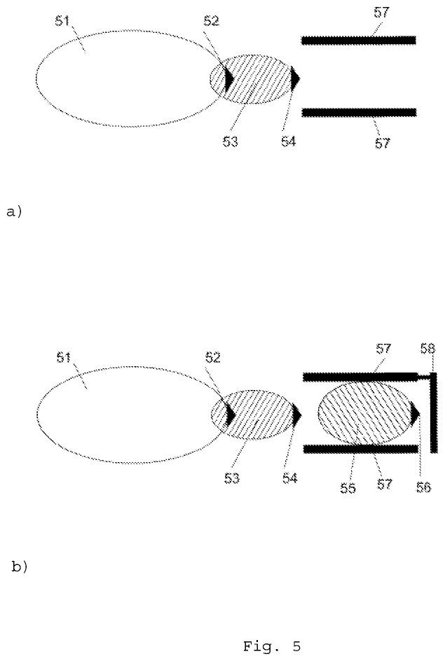

A particular embodiment of the invention is described further in the case when the second key consists of several parts, on the example of admittance to a section of toll road. Said embodiment is presented in FIG. 5 for the case (a) of a system of automobile travel not blocking the road and for the case (b) of a system with a pass-through device.

FIG. 5a shows schematically a point for admittance to a section of toll road in the form of a system with no barrier to passage. The admittance point is equipped with at least one metering section formed by limiters 57. The entry zone in front of the metering section is in the form of a first entry zone 51 and a second entry zone 53, which are formed by first and second transceivers 52 and 54, respectively. The first and second entry zones 51 and 53 are arranged such that a means of transportation, approaching the corresponding metering section, at first enters the first entry zone 51, and then the second entry zone 53. As shown in FIG. 5a, the first entry zone has larger dimensions than the second entry zone 53 and is adapted to sending data to a mobile device 10 on the approach to the passage point. The application installed on the mobile device 10 is adapted to receive the first part of the second key from the first transceiver 52 upon passing through the first entry zone 51. The dimensions of the first entry zone are chosen such that the mobile device has enough time to receive data from the transceiver 52 without decreasing speed and consequently, enter a state of readiness to send and receive the following data packets. Farther on, while moving toward a particular metering section as defined by the limiters 57, the mobile device 10 enters the second entry zone 53, where it receives the second part of the second key from the second transceiver 54. After that, the application sends the third data packet in the second entry zone 54 to the second transceiver 54, as described above, with the exception that the second key now consists of the first part of the second key and the second part of the second key. The sending of the third data packet to the second transceiver 54, and then to the local computer 40, as described above, in immediate proximity to the corresponding metering section of the passage point also takes account of the fact that the power of the transmitter of the mobile device 10 is generally much lower than the power of the first and second transceivers 52, 54. Thus, the mutual arrangement of the first and second entry zones 51, 53 and their dimensions can register the presence of the user of the mobile device 10 without decreasing the speed near the passage point.

FIG. 5b shows schematically a passage point on a section of toll road in the form of a system with pass-through device. As in the case of the system with no barrier to passage, the passage point is equipped with at least one metering section, formed by limiters 57. The limiters 57 are equipped with a pass-through device 58 able to open and close, such as a gate. The entry zone in front of the metering section is in the form of a first entry zone 51 and a second entry zone 53, which are formed by a first and second transceivers 52 and 54, respectively. In addition, the entry zone comprises a third entry zone 55 formed by a third transceiver 56. All of the transceivers 52, 54, 56 are linked with a local computer 40 by a line of communication 34. After receiving the third data packet from the mobile device 10, the local computer 40 performs a verification of the data received. If the data from the third data packet are true, the mobile device 10 receives from the local computer 40 via the third transceiver 56 a fourth data packet with a third key and creates a ticket containing a first digital container, as described above. In parallel with this, a second digital container is created on the local computer 40, as described above. After creating the first digital container in the ticket on the mobile device 10 and the second digital container on the local computer 40, the pass-through device 58 opens, and the user gains access to the section of toll road.

It is also provided that there are two transceivers 52, 54 with directional antennas at each toll payment point, and the signal from the transceivers at each payment point contains its own second key consisting of two parts, being strictly defined for this passage point and not coinciding with the second keys of the other payment points. Accordingly, at the start of the road the mobile device 10 with the application, having received the second key consisting of two parts at the first toll payment point, creates a ticket containing the first digital container, comprising the first key and the second key of the first toll payment point, and sends a third data packet, as described above, on a wireless line of communication to the second transceiver 54, which is connected by a wireline or wireless communication to the local computer 40. A second container is created on the local computer 40 of the first toll payment point, as described above. The passing through every successive payment point may be accompanied by the closing of the corresponding first digital container and the creation of a new first digital container.

Upon passing through the second toll payment point, the mobile device 10 with application receives a second key of the second toll payment point, consisting of two parts, and sends a third data packet, containing information about the first key, the second key of the second payment point, and the second key of the first, i.e. previous payment point by a wireless communication channel 14 to the local computer of the second toll payment point. That is, the mobile device sends the data contained in the two first digital containers so created.

Thus, the local computer of each successive toll payment point verifies the travel through its zone and, at the same time, collects data on the travel of the user in the preceding zones, collecting and sending a signal containing this information to the central server in the form of a copy of the corresponding second digital container on the central server 50. The mobile device 10 upon crossing through each successive payment point closes the first digital container of the previous section of toll road and opens a new first digital container for the current section of toll road, corresponding to that payment point. The identification of the second containers associated with a single trip of the user through different given zones is done by comparing the identifiers of the second containers or the transit keys contained therein.

Similar to the example given above, user access can be provided for travel through a system of turnstiles for different routes in a subway system.

When using the system according to the present invention in a subway when turnstiles are present, the system allows any of the passages in a turnstile line to be converted into a non-barrier express line. This is done because payment or opening of the ticket container is done automatically for a user having a mobile device 10 with the application; the turnstile opens and the user passes through the turnstile without stopping in front of it. The user is not required to perform any actions, and the payment can be transacted according to the use of the given transportation according to personalized time, zone, or distance rates.

Unimpeded passage through a turnstile is done as follows.

The mobile device 10 with application receives the second key upon entering the entry zone 20 created by the lobes of the directionality diagram of the directional antennas of the transceivers 30. The application creates the third packet, consisting of the identifiers of the transceivers 30 and the first and second keys, and sends the third packet by wireless line of communication 14 to the local computer 40. The local computer 40 checks the validity of the data from the third data packet and transmits a fourth packet with a third key, and if necessary a transit key, to the application. The transit key is used only if the subway has entrance turnstiles and exit turnstiles to perform a verification of the user at the exiting and opening the turnstile upon exiting from the subway. Alternatively, the application receives the transit key at the same time as the second key from the transceivers 30 with directional antennas in the entry zone 20 at the entrance turnstiles, the transit key being used in a communication from the application which is sent on the line of communication 13 to the transceivers 30 with directional antennas forming a zone similar to the entry zone 20 near the exit turnstile, and then to the local computer 40. After the local computer 40 verifies the data received with the transit key, a signal is produced to open the exit turnstiles.

Upon exiting from the subway, the application enters an exit zone, formed similar to the entry zone 20 by means of transceivers 30 with directional antennas, and receives an additional second key using the internal transit key for reporting the additional second key, wherein the signal containing this communication is sent by wireless communication channel to the local computer 40 of the exit zone for recognition, receiving of the third key, creation of a new first digital container, and sending of a signal to open the exit turnstile.

When traveling on the subway when no turnstile is present, actions similar to the above are performed, but without sending a command to open the turnstile.

Possible embodiments of the method and system according to the present invention are not limited to the examples given above and will be understood by a person skilled in the art on the basis of the above.

1-28. (canceled)

29. A method for registering the presence of a user in a given zone (70), wherein the user is equipped with a mobile user device (10) with a pre-installed user mobile application on the mobile user device (10), and the user gains access to the given zone (70) by at least one entry zone (20),
the method comprises the following steps performed in sequence:
during or after installation of the application on the mobile device (10), a first data packet containing a first key is transmitted from a central server (50) or local computer (40) to the application,
when the user mobile device (10) with the application installed thereon enters the entry zone (20) of the given zone (70), a second data packet containing a second key known to the local computer (40) is transmitted wirelessly to the application, wherein transmission of the second data packet is done by means of at least one transceiver (30) with a directional antenna, creating the entry zone (10),
a third data packet containing data about the first and second keys, an identifier of the user mobile device, and/or SIM card identification data is transmitted from said user mobile device (10) with installed application to the local computer (40) via the at least one transceiver (30),
wherein
on the basis of the present first and second keys, a ticket containing at least one fillable first digital container is generated in the application, the ticket is saved in the user mobile device (10), and at least one fillable second digital container containing the third data packet is generated on the local computer (40), the second digital container being saved on the local computer (40), and after the local computer (40) receives the third data packet, a verification of the data received is done by the local computer (40),
if the reliability of the data so received is confirmed, a wireless communication channel is established between the local computer (40) and the mobile device (10) of the user with the installed application, by which a fourth data packet containing a third key is sent from the local computer (40) to the mobile user device (10),
after receiving the fourth data packet created in the application on the mobile user device (10), the first digital container is filled up with data on the third key, the filled first digital container is saved in the ticket in the mobile user device (10), and a fifth data packet containing data on the identifier of the first digital container is sent from the mobile device (10) to the local computer (40), in which data on the identifier of the first digital container are likewise saved in the second digital container,
wherein the first and second digital containers are closed in the event of occurrence of at least one of the following conditions:
if the local computer (40) does not receive a reply from the mobile user device (10),
if the mobile user device (10) does not receive a signal from the local computer (40) after a given interval of time,
if the user with the mobile user device (10) crosses through the entry zone (20) for a second time,
when the mobile user device (10) is located in a means of transportation having a route through the given zone (70), upon command from the local computer (40) before opening the doors at the next stop of the means of transportation, wherein in this case the first and second digital containers are again opened on command from the local computer (40) after closing the doors or the corresponding first and second digital containers are left closed and a new first and second digital container are opened,
on command from the local computer (40).

30. The method according to claim 29, wherein it is additionally provided that the mobile device (10) of the user is situated successively in several given zones (70), wherein a transit key from a central server (50) or local computer (40) is transmitted to the mobile device (10), and wherein the mobile device (10) enters the entry zone (20) of the first and each subsequent given zone (70)
i. the mobile device (10) fills up the first digital container with the transit key and sends the third data packet, filled with the transit key, to the local computer (40), or
ii. if the local computer (40) does not receive a reply from the mobile device (10) of the user or if the signal from the local computer (40) is not received by the mobile device (10) of the user after a given interval of time, or on command from the local computer (40), the mobile device (10) closes the existing first digital container and creates a new first digital container, in which the first key is replaced by the transit key or in which the transit key is used jointly with the first key, fills up the ticket with the new first digital container, and sends the third data packet with the new first digital container to the local computer (40),
wherein the local computer creates a new second digital container by using the third data packet so received.

31. The method according to claim 29, wherein at least one entry zone (20) is equipped with a pass-through device (58), wherein after the fifth data packet is received by the local computer (40), a signal is produced on the local computer (40) to open the pass-through device (58) and the signal so produced is sent to open the pass-through device (58).

32. The method according to claim 29, wherein during the presence of the user in the given zone (70) an exchange of additional data occurs between the local computer (40) and the mobile user device (10) and/or between the mobile user device (10) and other mobile devices (10) of other users situated in the given zone (70) that are in the receiving zone of the mobile user device (10), and the additional data are saved in the first and second digital containers in the mobile user device (10) and in the local computer (40), respectively.

33. The method according to claim 29, wherein the data in the first and second digital containers are saved in blockchain form.

34. The method according to claim 29, wherein the given zone (70) is a route of a means of transportation or a section of a toll road, the exchanging of additional data occurring when the means of transportation passes through a stop along the route or at reference points of the section of toll road, respectively, wherein at least one first and/or at least one second digital container additionally contains a record of events connected with the exchange of additional data.

35. The method according to claim 29, wherein the given zone (70) is a route of a means of transportation, and in the event that the mobile user device (10) is in the passenger compartment of the means of transportation traveling on its route through the given zone (70) the passenger compartment comprises an additional given zone, which is created with the aid of an additional transceiver (30) with directional antenna, the additional given zone being limited to one passenger seat, and information on the user with the mobile device (10) located in the additional given zone is saved in the first and second digital containers.

36. The method according to claim 29, wherein the entry zone (20) comprises a first entry zone (51) and a second entry zone (53), wherein the second data packet with the second key is sent to the mobile device (10) in the form of two packets, each of which containing a portion of the second key, wherein the first portion of the second data packet containing the first portion of the second key is sent to the mobile device (10) when the mobile device (10) enters the first entry zone (51), and then the second portion of the second data packet containing the second portion of the second key is sent when the mobile device (10) enters the second entry zone (53), wherein the first (51) and second (53) entry zones being arranged such that the mobile device (10) approaching the entry zone (20) first enters the first entry zone (51), and then into the second entry zone (53).

37. The method according to claim 29, wherein when two transceivers (30) with directional antennas are present, the entry zone (20) is created by the intersection of the beams of the directional antennas of the transceivers (30) to create a three-dimensional entry zone (20), wherein each of the beams is specified by corresponding lobes (60) of the directionality diagram of the corresponding directional antenna.

38. The method according to claim 29, wherein after completing the creation of the first digital container, the contents of the first digital container are additionally sent from the mobile device (10) to the central server (50).

39. The method according to claim 38, wherein after completing the creation of the second digital container the contents of the second digital container are additionally sent to the central server (50) from the local computer (40) of the given zone (70), wherein the contents of the first and second digital containers are sent independently of each other from the mobile device (10) and from the local computer (40), respectively, to the central server (50).

40. A system for registering the presence of a user in a given zone, wherein the user gains access to the given zone (70) by at least one entry zone (20), the system comprising:
a central server (50),
a local computer (40),
at least one transceiver (30) with a directional antenna, adapted to create an entry zone (20), wherein at least one transceiver (30) is linked to the local computer (40) by a communication line, and
a mobile user device (10) with mobile user application pre-installed thereupon,
wherein the central server (50) or the local computer (40) are linked by a communication channel to the mobile device (10) for the sending of a first data packet, containing a first key, to the mobile device (10), and the central server (50) is adapted to establish a link with the local computer (40),
wherein the transceiver (30) with directional antenna is adapted to send a second data packet, containing a second key known to the local computer (40), to said application, and to receive from the mobile device (10) a third data packet, containing data on the first and second keys, the identifier of the mobile user device, and/or identification SIM card data, and then send it to the local computer (40) by wireless communication channel,
wherein
the user mobile device is adapted to create a ticket containing at least one fillable first digital container, after receiving the first and second keys and saving the ticket in the mobile user device (10),
wherein the local computer (40) is adapted
to create at least one fillable second digital container, containing a third data packet, and to save the second digital container on the local computer (40),
to perform a verification of the data received in the form of the third data packet,
to establish a wireless communication channel between the local computer (40) and the mobile device (10) of the user after confirming the reliability of the data,
to send a fourth data packet containing a third key to the mobile device (10) with the application by the established communication channel,
wherein the application on the mobile user device (10) is adapted to complement the first digital container with data on the third key, to save the filled first digital container in the ticket in the mobile user device (10), and to send a fifth data packet containing data on the identifier of the first digital container from the mobile device (10) to the local computer (40), which is adapted to save the data on the identifier of the first digital container in the second digital container,
wherein the system is adapted to close the first and second digital containers in the event of occurrence of at least one of the following conditions:
if the local computer (40) does not receive a reply from the mobile user device (10),
if the mobile user device (10) does not receive a signal from the local computer (40) after a given interval of time,
if the user with the mobile user device (10) crosses through at least one entry zone (20) for a second time,
when the mobile user device (10) is located in a means of transportation having a route through the given zone (70), upon command from the local computer (40) before opening the doors at the next stop of the means of transportation, wherein in this case the first and second digital containers are again opened on command from the local computer (40) after closing the doors or the corresponding first and second digital containers are left closed and a new first and second digital container are opened,
on command from the local computer (40).

41. The system according to claim 40, wherein the mobile device (10) of the user is adapted to receive a transit key from the central server (50) or local computer (40), wherein when the mobile device (10) enters the entry zone (20) of the first and each subsequent given zone (70), it is adapted
i. to fill the first digital container with the transit key and send a fifth data packet, filled with the transit key, to the local computer (40), or
ii. if the local computer (40) does not receive a reply from the mobile device (10) of the user or if the signal from the local computer (40) is not received by the mobile device (10) of the user after a given interval of time, or on command from the local computer (40), the mobile device (10), to close the existing first digital container and create a new first digital container, in which the first key is replaced by the transit key or in which the transit key is used jointly with the first key, to fill the ticket with the new first digital container, and to send the fifth data packet with the new first digital container to the local computer (40),
wherein the local computer (40) is adapted to create a new second digital container by using the fifth data packet so received.

42. The system according to claim 40, wherein at least one entry zone (20) is equipped with a pass-through device (58), wherein after the fifth data packet is received by the local computer (40) the local computer is adapted to open the pass-through device (58) and to send the signal so produced to open the pass-through device (58).

43. The system according to claim 40, wherein the local computer (40) and the mobile user device (10) are adapted to exchange additional data between them and/or between the mobile user device (10) and other mobile devices (10) of other users situated in the given zone (70) that are in the receiving zone of the mobile user device (10), during the presence of the user in the given zone (70), and to save the additional data the first and second digital containers in the mobile user device (10) and in the local computer (40), respectively.

44. The system according to claim 40, wherein the data in the first and second digital containers are saved in blockchain form.

45. The system according to claim 40, wherein the given zone (70) is a route of a means of transportation or a section of a toll road, the system being adapted to exchange additional data when the means of transportation passes through a stop along the route or at reference points of the section of toll road, wherein at least one first and/or at least one second digital container additionally contains a record of events connected with the exchanging of additional data.

46. The system according to claim 40, wherein the passenger compartment of the means of transportation comprises an additional given zone, which is created with the aid of an additional transceiver (30) with directional antenna, wherein the additional given zone is limited to one passenger seat, and the mobile device (10) is adapted to save information on the user with the mobile device (10) being located in the additional given zone in the first and second digital containers.

47. The system according to claim 40, wherein the entry zone (20) comprises a first entry zone (51) and a second entry zone (53), wherein the second data packet with the second key is in the form of two packets, each of which contains a portion of the second key, wherein the system being adapted to send at first the first portion of the second data packet containing the first portion of the second key to the mobile device (10) when the mobile device (10) enters the first entry zone (51), and then the second portion of the second data packet containing the second portion of the second key when the mobile device (10) enters the second entry zone (53), wherein the first (51) and second (53) entry zones are arranged such that the mobile device (10) approaching the entry zone (20) first enters the first entry zone (51), and then into the second entry zone (53).

48. The system according to claim 40, wherein the entry zone (20) is a three-dimensional entry zone, created by the intersection of the beams of the directional antennas of two transceivers (30), each of the beams being specified by corresponding lobes (60) of the directionality diagram of the corresponding directional antenna.

49. The system according to claim 40, wherein the mobile device (10) is adapted to send the contents of the first digital container in addition to the central server (50) after completing the creation of the first digital container.

50. The system according to claim 49, wherein the system is adapted to additionally send the contents of the second digital container to the central server (50) from the local computer (40) of the given zone (70) after completing the creation of the second digital container, and to send the contents of the first and second digital containers independently of each other from the mobile device (10) and from the local computer (40), respectively, to the central server (50).
